(19) United States
(12) Patent Application Publication
(10) Pub. No.: US 2004/0017030 A1
(43) Pub. Date: Jan. 29, 2004

(54) Pneumatic spring assembly

(76) Inventors: Stephan Dehlwes, Bremervorde (DE); Helmut Lau, Mullheim/Niederweiler (DE)

Correspondence Address: Collard & Roe, 1077 Northern Boulevard, Roslyn, NY, 11576, US

(21) Appl. No.: 10/363,197

(22) PCT Filed: Jun. 25, 2002
(86) PCT No.: PCT/DE02/02316

(30) Foreign Application Priority Data
Jul. 5, 2001 (DE) 10132061.2

(51) Int. Cl. F16F 9/14

(52) U.S. Cl. 267/64.15; 267/64.23

(57) ABSTRACT

The invention relates to a pneumatic spring assembly comprised of at least one pressure reservoir (1) with a connection to the chassis, with a roll-off piston, a pneumatic spring bellows (2), which encloses a volume-elastic air chamber (3), and with a shock absorber comprising, in turn, a reservoir tube and a piston rod (12) that dips into the reservoir tube in a sliding manner. The pressure reservoir (1) comprises a pressure chamber (4) and a, for the most part, pot-shaped accommodating chamber (5), whereby a shock-absorber bearing (6) comprising an elastomer body (7) and a supporting piece (8) can be placed inside said accommodating chamber (5). The inventive pneumatic spring assembly is characterized in that the pressure reservoir (1) is provided with a dynamic seal (16) in the area of the bottom opening (11) of the accommodating chamber (5). Said seal seals the pressure chamber (4) whereby also sealing the volume-elastic air chamber (3) and, in fact, while simultaneously adapting to the amplitudes and movements of the piston rod (12).

### DESCRIPTION

The invention relates to a pneumatic spring assembly, comprising at least:

a pressure reservoir with attachment to the chassis, and a rolling piston, the pressure reservoir having a pressure chamber and a normally pot-like accommodating chamber, it being possible in turn for a shock-absorber bearing, which comprises an elastomer body and a supporting piece, to be inserted into the accommodating chamber;

a pneumatic spring bellows of elastomeric material, which is normally provided with an embedded strength support, the two bellows ends being fixed to the pressure reservoir at one end and to the rolling piston at the other end, as a result of which the pneumatic spring bellows encloses a volume-elastic air chamber, the pneumatic spring bellows also forming a loop which can slide along on the outer wall of the rolling piston; and

a shock absorber, comprising a container tube which, at least in some sections, is surrounded by the rolling piston, and a piston rod, which is firmly connected via a bottom opening of the accommodating chamber to the supporting piece of the shock-absorber bearing and penetrates into the container tube in a sliding manner.

Pneumatic spring assemblies of this type—also called pneumatic spring legs—are predominantly used in vehicle engineering, preferably in turn in the front and rear suspension of motor vehicles, reference being made in particular to the following documents in relation to the relevant prior art:

DE 100 50 028 Al

DE 196 07 804 Cl

DE 196 45 228 Al

DE 198 26 480 Al

DE 199 07 672 Cl

U.S. Pat. No. 5,690,319

JP 07167189 A (Patent Abstracts of Japan)

The spring legs have the task of damping as highly as possible the forces which arise when travelling over any unevenness in the roadway. The introduction of the oscillation into the bodywork or into the chassis is taken place via the path of the shock-absorber bearing, also called the spring leg supporting bearing. Therefore, all possible ways of conducting the oscillation should ideally be interrupted by an elastomeric element. At the same time, the positive drive characteristics of the spring leg (for example ground adhesion) and directional guidance should remain unimpaired.

According to the prior art, substantially the following two configurations occur with regard to the shock-absorber bearing:

The shock-absorber bearing simultaneously performs the sealing of the air chamber, document DE 198 26 480 Al being cited as an example. However, a shock-absorber bearing of this type is subjected to high mechanical forces and to the high pressures which prevail within the air chamber, connected with rapid wear.

The shock-absorber bearing performs no sealing function. Sealing is provided via a pressure plate which seals off the accommodating chamber for the shock-absorber bearing at the top. In this case, the pressure plate is often constructed as a valve plate which ensures a build-up of pressure. In this regard, reference is made in particular to the document U.S. Pat. No. 5,690,319. Here, the shock-absorber bearing is subjected to high pressures, likewise connected with rapid wear.

Within the context of a further development, the object of the invention is to provide a pneumatic spring assembly of the generic type with which increased damping of the forces which act on the chassis is achieved, specifically from the point of view of adjustable pressure relationships, which can amount to up to 100 bar. At the same time, the shock-absorber bearing is to be relieved of pressure, specifically with the effect of a considerable reduction in pressure.

According to the characterizing part of patent claim 1, this object is achieved in that the pressure reservoir is provided, in the region of the bottom opening of the accommodating chamber, with a dynamic seal which seals off the pressure chamber and therefore also the volume-elastic air chamber, specifically whilst simultaneously adapting to the amplitudes and movements of the piston rod.

Expedient refinements of the invention are cited in patent claims 2 to 28.

The invention will now be explained using exemplary embodiments and with reference to schematic drawings, in which:

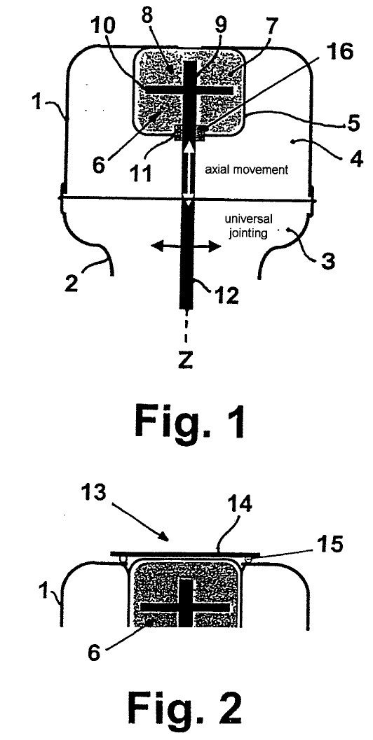

FIG. 1 shows a pressure reservoir with dynamic seal, the shock-absorber bearing being subjected only to atmospheric pressure;

FIG. 2 shows a pressure reservoir with dynamic seal according to FIG. 1, with an additional static seal;

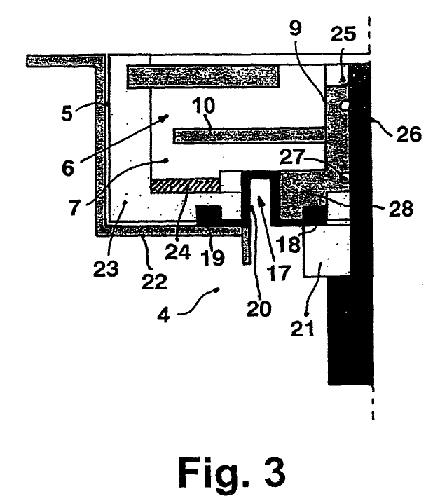

FIG. 3 shows a dynamic seal in the form of a rolling diaphragm.

According to FIG. 1, one end of the pneumatic spring bellows 2 of elastomeric material, which is normally provided with an embedded strength support, is fixed to the pressure reservoir 1, for example by means of a clamping ring. The other end of the bellows (not shown here) is connected to the rolling piston, as a result of which the pneumatic spring bellows encloses a volume-elastic air chamber 3. With regard to the interaction of pneumatic spring bellows and rolling piston, reference is made to the prior art cited at the beginning.

The pressure reservoir 1 comprises a pressure chamber 4 which, together with the air chamber 3, forms a common pressure system, and an accommodating chamber 5 which, within the core area of the pressure reservoir, penetrates in the manner of a pot into the pressure chamber. In addition, the pressure chamber can be provided with a valve (DE 198 19 642 Al).

The shock-absorber bearing 6 is then inserted into the accommodating chamber 5 and, because of its production, is a separate component. The shock-absorber bearing comprises an elastomer body 7 and a supporting piece 8, which in turn comprises a central supporting element 9 and a load-bearing disk 10 arranged at right angles to the supporting element. In this case, the supporting piece is connected to the elastomer body in a firmly adhering manner. The central supporting element, which runs within the region of the center of the load-bearing disk, is connected to the piston rod 12 of the shock absorber via the bottom opening 11 in the accommodating chamber. In this connection, the core area of the central supporting element 9 has in particular an inner tube running axially to accommodate the piston rod, reference being made in this regard to FIG. 3 and the corresponding description.

The elastomer body 7 of the shock-absorber bearing 6 is an unfoamed material, preferably based on natural rubber. Use can also be made of a foamed microcellular material, in particular one based on polyurethane rubber, preferably in turn based on polyester polyurethane. The combination of an unfoamed material with a foamed material can also be used.

The constructional and material-specific measures presented in more detail here additionally contribute to an increased lifetime of the shock-absorber bearing.

In the region of the bottom opening 11 of the accommodating chamber 5, the pressure reservoir 1 is provided with a dynamic seal 16 of polymer material, which adapts to the axial movement in the Z direction and the universal jointing, very high requirements being placed on such a seal, owing to the conditions listed below, specifically:

amplitudes of the piston rod of about +/−10 mm in the Z direction;

movement of the piston rod of about +/−2 mm in the plane at right angles to the Z direction;

cardanic movement of the piston rod of up to about +/−8°;

additionally high pulse loads;

possible longer-lasting micro-oscillations;

no increase in the stiffness of the shock-absorber bearing.

In this connection, the dynamic seal 16 is advantageously arranged in the vicinity of the cardanic point of the shock-absorber bearing 6.

Since the seal 16 seals off the bottom opening 11 of the accommodating chamber 5, the shock-absorber bearing 6 here is located outside the pressure area. The shock-absorber bearing is therefore subjected only to external atmospheric pressure, associated with a long lifetime. Furthermore, replacement of the shock-absorber bearing 6 if required is possible.

According to a variant according to FIG. 2, the pressure reservoir 1 can additionally be provided with a static seal 13 which seals off the top area of the accommodating chamber and at the same time acts as an emergency seal in the event of failure of the dynamic seal. The seal 13 comprises a sealing plate 14 of metal or an appropriate plastic (e.g. glass fiber reinforced plastic) and a sealing ring 15 of polymer material, preferably based on an elastomer or thermoplastic elastomer. In conjunction with appropriate fixing means, for example by being screwed to the pressure reservoir or to the central supporting element or to the piston rod, a tight closure is ensured. Furthermore, replacement of the shock-absorber bearing 6 if required is also possible here.

Instead of the sealing plate 14 and the sealing ring 15, the seal 13 can comprise a curable sealing compound which closes the accommodating chamber permanently.

With this combination system, however, the encapsulated shock-absorber bearing 6 is subjected to a somewhat increased pressure as compared with the exemplary embodiment according to FIG. 1. As opposed to the pneumatic spring leg according to U.S. Pat. No. 5,690,319, however, the new sealing concept also means that a considerable reduction in pressure is provided here.

FIG. 3, then, shows a particularly advantageous embodiment of the dynamic seal in the form of a rolling diaphragm 17, which comprises the following diaphragm areas:

a first diaphragm end 18, which faces the piston rod 12 of the shock absorber;

a second diaphragm end 19, which faces away from the piston rod 12; and

a rolling area 20 extending between the two diaphragm ends.

The rolling diaphragm 17 based on an elastomer or thermoplastic elastomer preferably has an embedded strength support, which is a fabric with thread reinforcements running in a crossed manner or consists of thread reinforcements running axially. The material used is in particular polyester, polyamide or polyimide.

The diaphragm ends 18 and 19, which are thickened, are fixed by means of retaining and pressing parts. For instance, the first diaphragm end 18 is clamped in between a broadened foundation 28 of the supporting piece 8 or the central supporting element 9 of the shock-absorber bearing and an additional bottom element 21. The second diaphragm end 19 is clamped in between the bottom 22 of the accommodating chamber 5 and a retaining and pressing part 23 seated thereon. Furthermore, a spacer 24 is arranged between this retaining and pressing part and the elastomer body 7 of the shock-absorber bearing.

The rolling diaphragm 17 seals off the pressure chamber 4 with respect to the accommodating chamber 5 effectively in the manner described here, and does so whilst fulfilling the requirement profile cited above. Furthermore, it can be replaced if required.

The core area of the central supporting element 9 of the supporting piece comprises an inner tube running axially to accommodate the piston rod 12 of the shock absorber, specifically in conjunction with a screw fixing 25. Additionally arranged between the piston rod 12 and the inner tube wall 26 are two sealing rings 27 of polymer material, preferably again based on an elastomer or thermoplastic elastomer.

According to a further advantageous refinement of the invention, the air chamber 3 or pressure chamber 4 is partly or completely filled with an inert gas or an inert gas mixture, preferably based on nitrogen and/or carbon dioxide and/or a noble gas. This increases the lifetime of the dynamic seal, since the reactive oxygen in the air can attack the materials of the seals, because of its oxidizing action.

The term “air” or “pneumatic” used here in the context of the designations which are generally common, such as pneumatic spring assembly, pneumatic spring leg, pneumatic spring bellows and air chamber, also comprises gases or gas mixtures which differ from the usual composition of air.

List of Designations

| | |
|---|---|
| 1 | Pressure reservoir |
| 2 | Pneumatic spring bellows |
| 3 | Volume-elastic air chamber |
| 4 | Pressure chamber |
| 5 | Accommodating chamber |
| 6 | Shock-absorber bearing |
| 7 | Elastomer body |
| 8 | Supporting piece |
| 9 | Central supporting element |
| 10 | Load-bearing disk |
| 11 | Bottom opening of the accommodating chamber |
| 12 | Piston rod of the shock absorber |
| 13 | Static seal |
| 14 | Sealing plate |
| 15 | Sealing ring |
| 16 | Dynamic seal |
| 17 | Rolling diaphragm |
| 18 | First diaphragm end |
| 19 | Second diaphragm end |
| 20 | Rolling area |
| 21 | Additional bottom element |
| 22 | Bottom of the accommodating chamber |
| 23 | Retaining and pressing part |
| 24 | Spacer |
| 25 | Screw fixing |
| 26 | Inner tube wall |
| 27 | Sealing ring |
| 28 | Broadened foundation of the supporting piece or |
| | supporting element |

1. A pneumatic spring assembly, comprising at least:
a pressure reservoir (1) with attachment to the chassis, and a rolling piston, the pressure reservoir having a pressure chamber (4) and a normally pot-like accommodating chamber (5), it being possible in turn for a shock-absorber bearing (6), which comprises an elastomer body (7) and a supporting piece (8), to be inserted into the accommodating chamber;
a pneumatic spring bellows (2) of elastomeric material, which is normally provided with an embedded strength support, the two bellows ends being fixed to the pressure reservoir (1) at one end and to the rolling piston at the other end, as a result of which the pneumatic spring bellows encloses a volume-elastic air chamber (3), the pneumatic spring bellows also forming a loop which can slide along on the outer wall of the rolling piston; and
a shock absorber, comprising a container tube which, at least in some sections, is surrounded by the rolling piston, and a piston rod (12), which is firmly connected via a bottom opening (11) of the accommodating chamber (5) to the supporting piece (8) of the shock-absorber bearing (6) and penetrates into the container tube in a sliding manner;
characterized in that
the pressure reservoir (1) is provided, in the region of the bottom opening (11) of the accommodating chamber (5), with a dynamic seal (16, 17) which seals off the pressure chamber (4) and therefore also the volume-elastic air chamber (3), specifically whilst simultaneously adapting to the amplitudes and movements of the piston rod (12).

2. The pneumatic spring assembly as claimed in claim 1, characterized in that the dynamic seal (16, 17) is installed in such a way that it can be replaced.

3. The pneumatic spring assembly as claimed in claim 1 or 2, characterized in that the dynamic seal (16, 17) consists of a polymer material, preferably based on an elastomer or thermoplastic elastomer.

4. The pneumatic spring assembly as claimed in claim 3, characterized in that the dynamic seal is designed as a rolling diaphragm (17), specifically comprising the following diaphragm areas:
a first diaphragm end (18), which faces the piston rod (12) of the shock absorber;
a second diaphragm end (19), which faces away from the piston rod (12); and
a rolling area (20) extending between the two diaphragm ends (18, 19).

5. The pneumatic spring assembly as claimed in claim 4, characterized in that the rolling diaphragm (17) has an embedded strength support.

6. The pneumatic spring assembly as claimed in claim 5, characterized in that the strength support is a fabric with thread reinforcements running in a crossed manner.

7. The pneumatic spring assembly as claimed in claim 5, characterized in that the strength support consists of thread reinforcements running axially.

8. The pneumatic spring assembly as claimed in one of claims 5 to 7, characterized in that the strength support consists of polyester, polyamide or polyimide.

9. The pneumatic spring assembly as claimed in one of claims 4 to 8, characterized in that the two diaphragm ends (18, 19) are thickened.

10. The pneumatic spring assembly as claimed in one of claims 4 to 9, characterized in that the two diaphragm ends (18, 19) are fixed by means of retaining and pressing parts.

11. The pneumatic spring assembly as claimed in claim 10, characterized in that the first diaphragm end (18) is clamped in between a broadened foundation (28) of the supporting piece (8) and an additional bottom element (21).

12. The pneumatic spring assembly as claimed in claim 10 or 11, characterized in that the second diaphragm end (19) is clamped in between the bottom (22) of the accommodating chamber (5) and a retaining and pressing part (23) seated thereon.

13. The pneumatic spring assembly as claimed in claim 12, characterized in that a spacer (24) is arranged between the retaining and pressing part (23) for the second diaphragm end (19) and the elastomer body (7) of the shock-absorber bearing (6).

14. The pneumatic spring assembly as claimed in one of claims 1 to 13, characterized in that the dynamic seal (16, 17) is arranged in the vicinity of the cardanic point of the shock-absorber bearing (6).

15. The pneumatic spring assembly as claimed in one of claims 1 to 14, characterized in that the elastomer body (7) of the shock-absorber bearing (6) is an unfoamed material, preferably based on natural rubber.

16. The pneumatic spring assembly as claimed in one of claims 1 to 14, characterized in that the elastomer body (7) of the shock-absorber bearing (6) is a foamed material, in particular on a microcellular basis, preferably based on polyurethane rubber, preferably in turn based on polyester polyurethane.

17. The pneumatic spring assembly as claimed in claim 15 and 16, characterized by the combination of an unfoamed material with a foamed material.

18. The pneumatic spring assembly as claimed in one of claims 1 to 17, characterized in that the supporting piece (8) comprises a central supporting element (9), which is connected to the piston rod (12) of the shock absorber, and at least one load-bearing disk (10) arranged at right angles to the supporting element, the supporting element running within the region of the center of the load-bearing disk.

19. The pneumatic spring assembly as claimed in one of claims 1 to 18, characterized in that the supporting piece (8) is connected to the elastomer body (7) in a firmly adhering manner.

20. The pneumatic spring assembly as claimed in one of claims 1 to 19, characterized in that the shock-absorber bearing (6) is subjected only to external atmospheric pressure.

21. The pneumatic spring assembly as claimed in one of claims 1 to 19, characterized in that a static seal is additionally arranged in the top area of the accommodating chamber (5).

22. The pneumatic spring assembly as claimed in claim 21, characterized in that the static seal (13) comprises a sealing plate (14).

23. The pneumatic spring assembly as claimed in claim 22, characterized in that the sealing plate (14) is additionally provided with a sealing ring (15) of polymer material, preferably based on an elastomer or thermoplastic elastomer.

24. The pneumatic spring assembly as claimed in claim 22, characterized in that the static seal comprises a curable sealing compound which closes the accommodating chamber (5) permanently.

25. The pneumatic spring assembly as claimed in one of claims 1 to 24, characterized in that the core area of the supporting piece (8) or of the central supporting element (9) comprises an inner tube running axially to accommodate the piston rod (12) of the shock absorber, in particular in conjunction with a screw fixing (25).

26. The pneumatic spring assembly as claimed in claim 25, characterized in that at least one sealing ring (27) of polymer material, preferably based on an elastomer or thermoplastic elastomer, is arranged between the piston rod (12) and the inner tube wall (26) of the supporting piece (8) or central supporting element (9).

27. The pneumatic spring assembly as claimed in one of claims 1 to 26, characterized in that the pressure chamber (4) or air chamber (3) is partly or completely filled with an inert gas or an inert gas mixture.

28. The pneumatic spring assembly as claimed in claim 27, characterized in that use is made of a gas or a gas mixture of nitrogen and/or carbon dioxide and/or a noble gas.
